(19) United States
(12) Patent Application Publication
(10) Pub. No.: US 2013/0175953 A1
(43) Pub. Date: Jul. 11, 2013

(54) Sequential pulse firing of multiple motors in an flywheel array

(71) Applicants: Carl William Astley, Llanddulas (GB); Dale Vernon Astley, Llanddulas (GB); Simon Mills, Old Colwyn (GB); Chris Rimell, Chester (GB); Kevin Nock, Towyn (GB); James Smith, Kinmel Bay (GB)

(72) Inventors: Carl William Astley, Llanddulas (GB); Dale Vernon Astley, Llanddulas (GB); Simon Mills, Old Colwyn (GB); Chris Rimell, Chester (GB); Kevin Nock, Towyn (GB); James Smith, Kinmel Bay (GB)

(21) Appl. No.: 13/714,156

(22) Filed: Dec. 13, 2012

Related U.S. Application Data
(60) Provisional application No. 61/576,488, filed on Dec. 16, 2011.

(51) Int. Cl. H02P 29/00

(52) U.S. Cl. CPC H02P 29/0005
USPC 318/161

(57) ABSTRACT

A method of initiating sequential pulse firing of a motor to reduce energy consumption in machines that have both rotational and linear kinetic energy stored in them by pulsing the motor at variable frequency without reducing total kinetic energy in the machine below a predetermined level.

### CROSS-REFERENCE TO RELATED APPLICATIONS

This application benefit Claims To Prior Applications under 35 U.S.C. §§119(e) Application No. 61/576,488 filing date Dec. 16, 2011

### PATENT HISTORY

Flywheels are used for power smoothing and power storage. The basic design and function of flywheels has remained unchanged since the Neolithic times.

### FIELD OF INVENTION

A flywheel is heavy revolving wheel in a machine that is used to increase the machine's momentum and thereby provide greater stability or a reserve of available power during interruptions in the delivery of power to the machine.

### BACKGROUND OF THE CONVENTIONAL ART

Flywheels are designed to store rotational kinetic energy by inputting energy into the flywheel by a coupling device connected to a motor and recovering energy by a generator through a coupling. Flywheel devices are found in all areas from clockwork pocket watches to automobile wheels. A flywheel is powered from its axis of rotation or its perimeter. For a given energy input a flywheel will accelerate to a terminal velocity when input force equals the total dissipative forces.

### SUMMARY OF THE METHOD

The method is a means for controlling and sequentially firing of a number of motors positioned in an flywheel array and coupled to a fixed drive plate causing the flywheel array to rotate around a common rotation axis maximising efficiency of the dynamic loads of the masses of the motor and any resultant rotational kinetic energy. The motors will have gained an optimum position in which to apply a pulse of energy to an individual or multiple motors in turn to accelerate the flywheel array. This optimum position and time of energy pulse will be dependent on the mass, diameter and total moment of inertia of the flywheel array and the rotational speed of the flywheel array. The method utilises the rotational kinetic energy stored in the flywheel array to minimise the loss of acceleration due to dissipative forces between each energy pulses, reducing the overall energy consumption, without loss of acceleration. As the rotational speed increases the time between the energy pulses can be increased as the rise in rotational kinetic energy will carry the momentum of the flywheel array to the next firing sequence before dissipative forces begin to take effect. The energy now required to impart one revolution can now be segmented. Segmenting the energy input will reduce the total energy consumption per revolution equating to greater motor efficiency. Sequential firing the motors in the planetary array with a pulse of impulse energy will accelerate the planetary array with every subsequent pulse of energy.

### DRAWINGS

Introduction to drawings:

FIG. 1 isometric view of a six motor array.

FIG. 2 six motor array mounted to inside of a tire and wheel rim.

FIG. 3 front view illustrating an ignition firing position.

FIG. 4 exploded isometric view of hub and motor array assembly.

FIG. 5 exploded isometric view of motors with a combined CPU, battery and capacitor discharge ignition unit(cdiu).

A=motor, B=drive-plate, C=shaft, D=gear, H=hub, M=cpu/battery/cdiu, R=wheel rim, S=pulse point, T=tire

### DETAILED DESCRIPTION OF THE METHOD

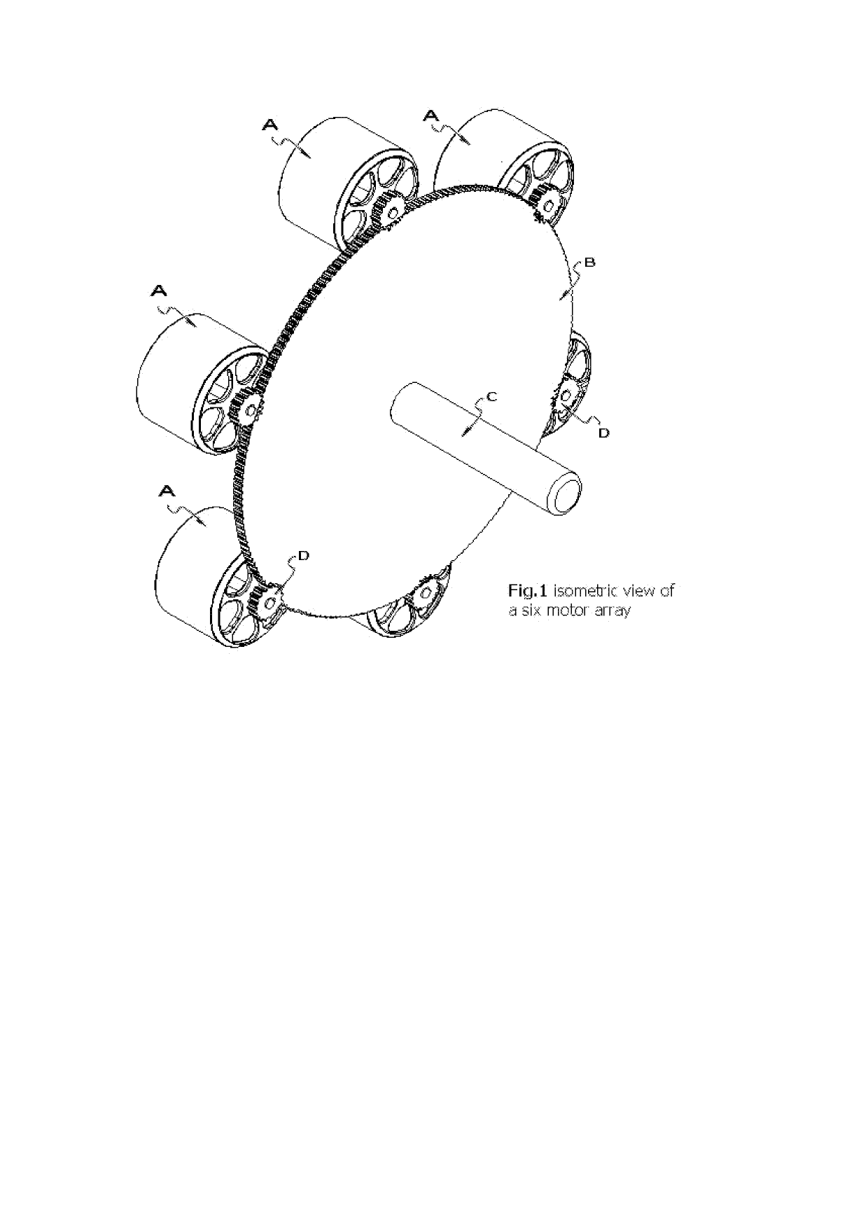

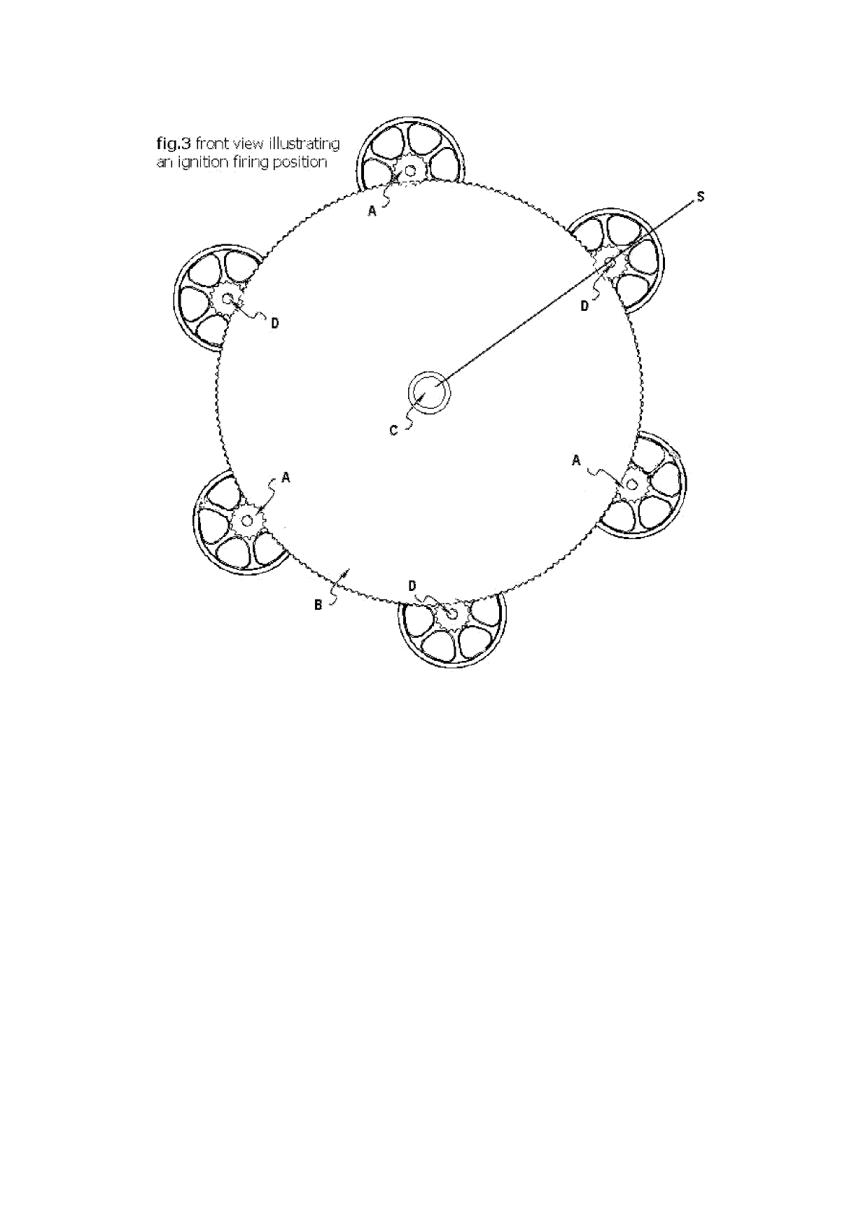

A method of controlling multiple motors FIG. 1(A) in a planetary flywheel array FIG. 1 to apply an input of impulse energy through the coupled said motors FIG. 1(A) in a sequential firing pattern which is determined by an algorithm of the rotational speed and total inertia of the said planetary flywheel array FIG. 1 in order to reduce the total amount of energy used per revolution of the said planetary array FIG. 1 without reducing the rotational kinetic energy per revolution of the said flywheel array FIG. 1. In the planetary flywheel array FIG. 1 each said motor FIG. 1(A) is sequentially fired at its possible optimum point FIG. 3(S) and each unique optimum point is calculated by a computer algorithm monitoring the rpm, load and calculating the total kinetic energy of the drive system and attached machines. The more kinetic energy that is available the longer the interval between the input of power pulses can be. The total energy consumed pre revolution is the summation of each individual energy pulse per single revolution of the said planetary flywheel array FIG. 1.

### Embodiments

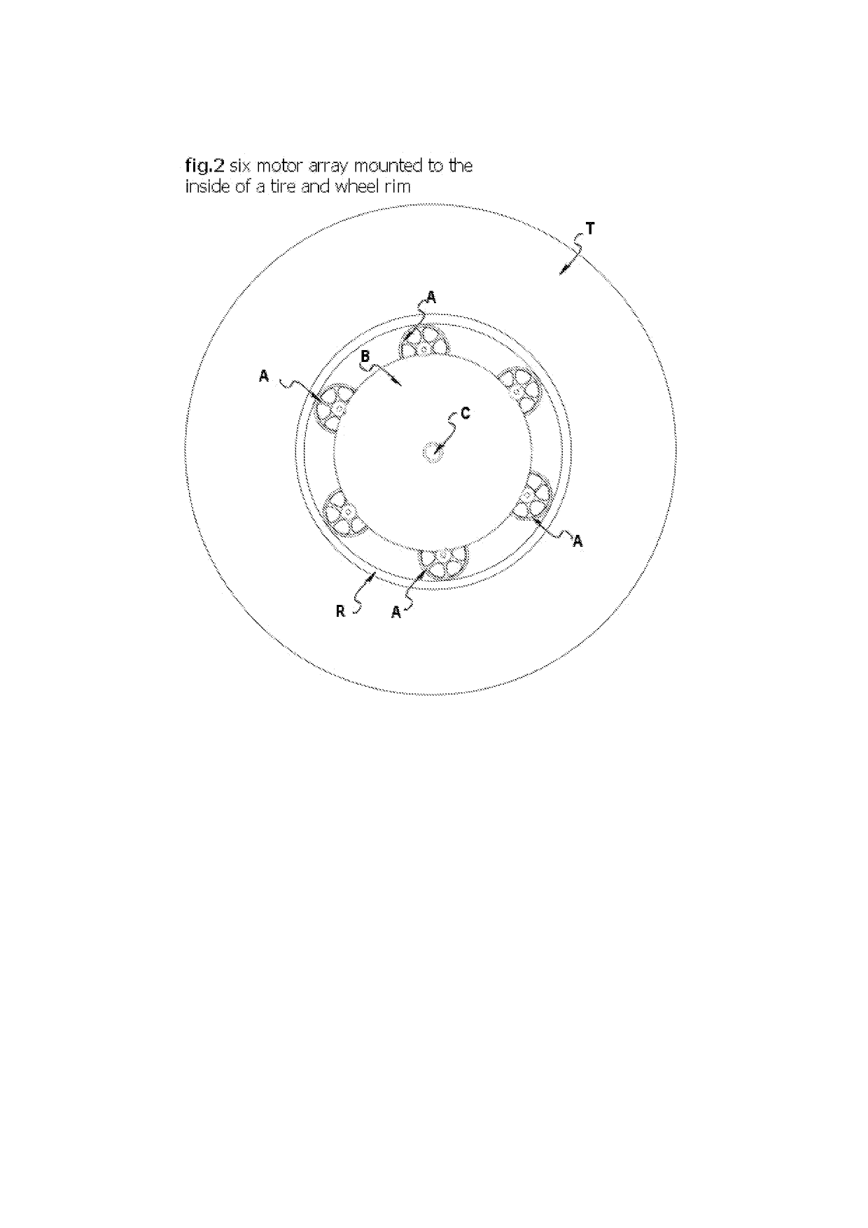

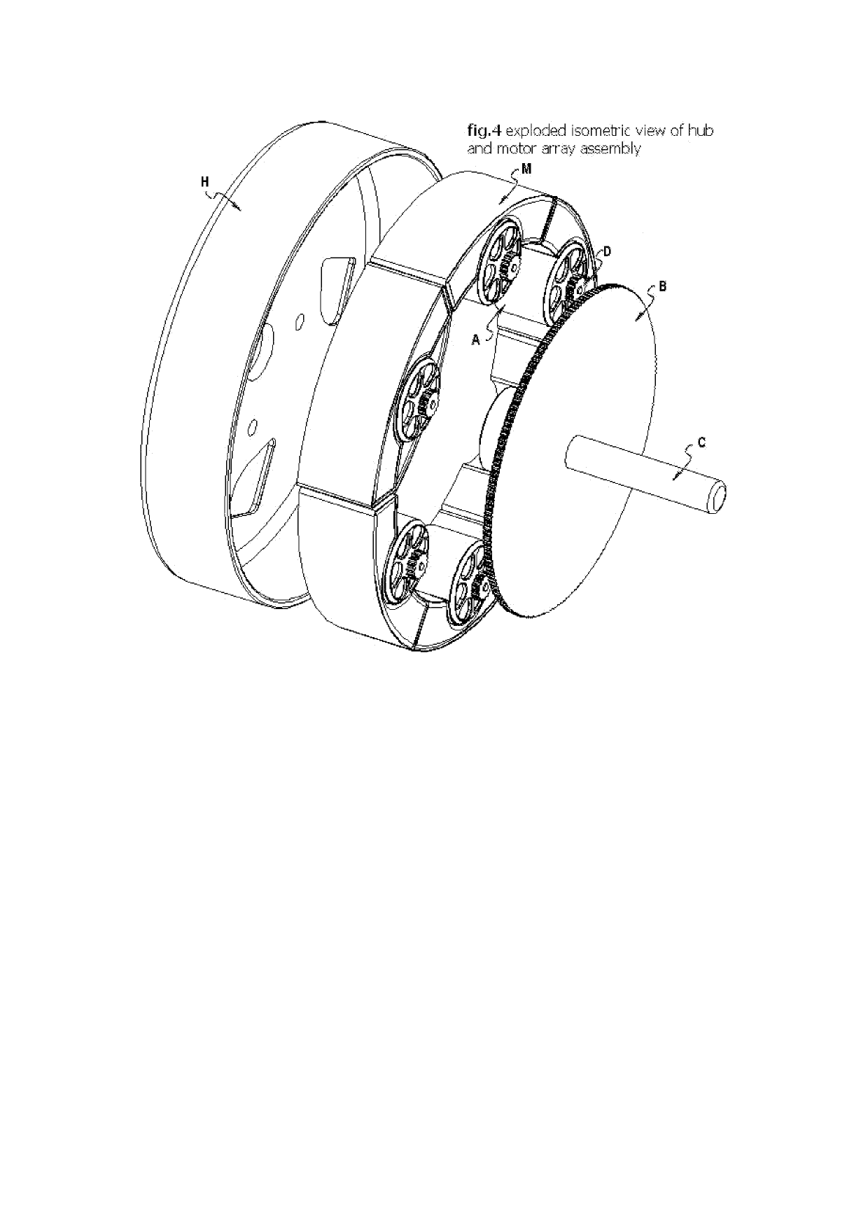

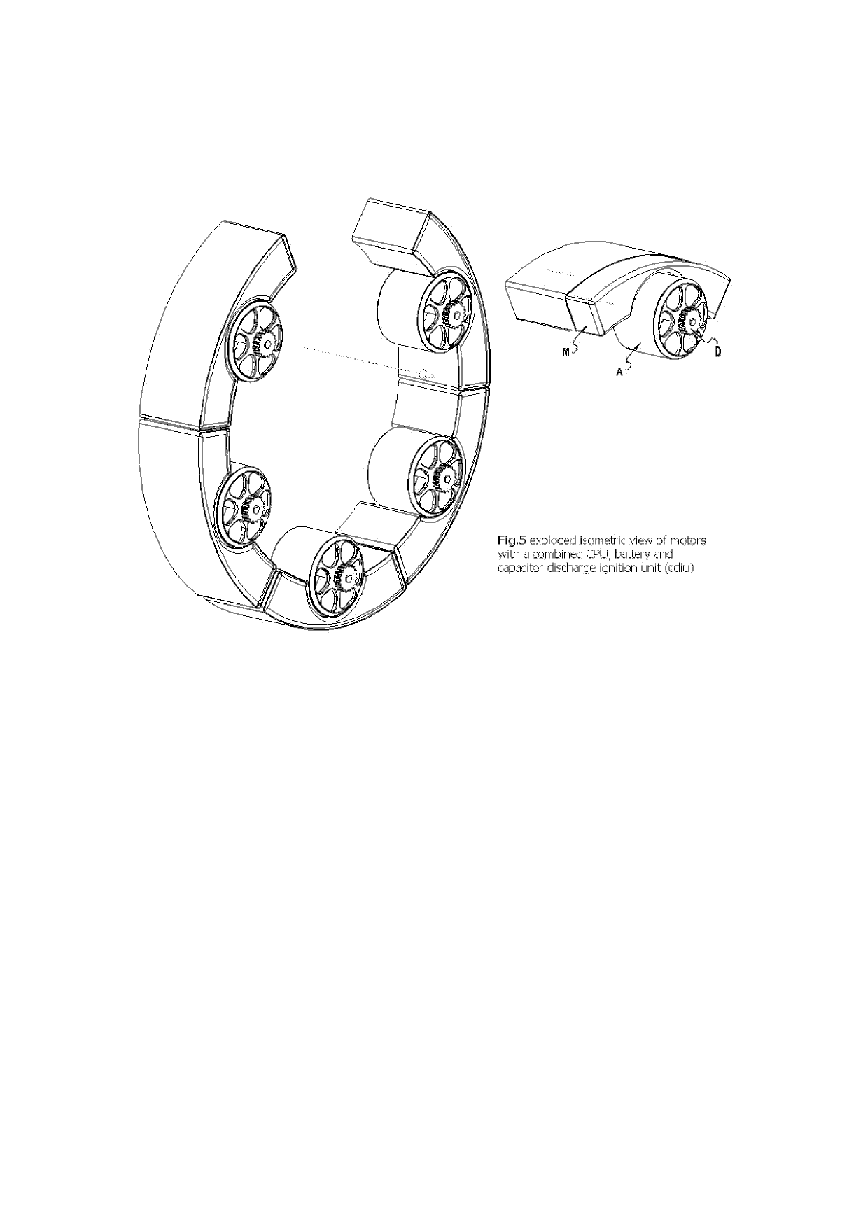

With the motor assemblies FIG. 1(A) being electric in FIG. 1 and coupled directly to the inside of a tire, wheel rim as a flywheel assembly as in FIG. 2, the device can be used as a drive mechanism on a vehicle rotating around a fixed drive plate FIG. 1(B) & shaft FIG. 1(C). On activating the method each motor can be started simultaneously or sequentially for maximum effect. As the motor array FIG. 1 accelerates the sequential ignition control uses the method to monitor the inertial load and kinetic energy of rotation, speed of the rotating array and any other parameters which improve energy efficiency & consumption. For any given variable of speed/load on the motors the method will determine a single or multiple optimum point(s) at which the next ignition pulse takes place on a motor(s) that will provide greatest efficiency. This is represented by a line ‘S’ in FIG. 3. Each time a motor passes this optimum variable point ‘S’ it is pulsed with additional energy accelerating the motor array FIG. 1. Incorporating the method as a computer program will allow it to be inserted into the control software of a conventional electric automobile or hybrid electric car and increase the overall efficiency substantially at appropriate higher speeds by reducing the electrical consumption from the automobiles onboard battery. Kinetic energy recovery systems (KERS) are used in Formula 1 (F1) racing cars. F1 cars have significant kinetic energy, both rotational and linear stored in them as they are driven. The method can be used to maximise battery life or by applying the power to the electric motor/generator in a sequential series of impulses, this will layer an acceleration phase on to the engine drive train for every impulse, increasing the efficiency of the power available from the batteries or condensers. FIG. 4 & FIG. 5 shows such a device that could attach to a automotive wheel rim showing six motors each with a combined CPU battery and capacitor discharge module.

### Advantages of This Method

Using arrays of motors which are sequentially pulsed fired (ignition) will allow the system to continuously accelerate to its theoretical maximum. The overall power consumption will be reduced and energy efficiency increased as the speed of rotation and kinetic energy increases. Pulsing motors will aid reliability and increase their life cycle.

We claim:

1. A method comprising a control to sequentially pulse a motor; and, or provide continuous power to a motor

2. A method as in claim 1; coupled to a mass; and rotating the mass

3. A method as in claim 1; where the method control monitors angular velocity of the mass assembly; and calculates the rotational inertia and kinetic energy of the mass assembly from inputted predetermined values; and uses these kinetic energy values based on predetermined levels when to initiate sequential pulsing and the duration of the pulse to each motor; and to subsequently stop sequential pulsing the motor; and provide the motor with continuous power when the kinetic energy falls below a predetermined level
